(19) United States
(12) Patent Application Publication
(10) Pub. No.: US 2025/0227428 A1
(43) Pub. Date: Jul. 10, 2025

(54) ACOUSTIC RENDERING WITHIN A LISTENING SPACE

(71) Applicant: Shure Acquisition Holdings, Inc., Niles, IL (US)

(72) Inventor: Roger GRINNIP, Lake Zurich, IL (US)

(21) Appl. No.: 18/989,173

(22) Filed: Dec. 20, 2024

Related U.S. Application Data
(60) Provisional application No. 63/618,433, filed on Jan. 8, 2024.

(51) Int. Cl. H04S 7/00

(52) U.S. Cl. CPC H04S 7/302; H04S 2400/11

(57) ABSTRACT

Audio of a presentation is provided within a listening space that replicates the spatial distribution of the acoustic pressure generated by the virtual or phantom source within the listening space. Speaker arrangement data indicating an arrangement of one or more speakers within the listening space is received and receiver data for receivers located within the listening space at a time corresponding to a presentation being provided within the listening space is determined. Presentation data corresponding to the presentation being provided within the listening space is determined based at least in part on the speaker arrangement data and the receiver data. One or more parameters of the one or more speakers within the listening space are adjusted based on the presentation data to enable provision of audio associated with the presentation within the listening space.

### CROSS-REFERENCE TO RELATED APPLICATION(S)

This application claims priority to U.S. Application No. 63/618,433, filed Jan. 8, 2024, the content of which is incorporated herein by reference in its entirety.

### FIELD

Various examples described herein relate to acoustic rendering within a listening space such as a conference room. For example, various examples relate to providing audio of a presentation (e.g., a video conference, a video presentation, etc.) within a listening space.

### BACKGROUND

Conference calls and live-streamed events have become common place in both people's workplaces and personal lives. For example, during a conference call or live-streamed event, a user may view video and be provided with audio captured in multiple remote places.

Conventionally, the audio is captured and provided in a manner that is independent of the acoustic space in which the user is listening to the audio.

### BRIEF SUMMARY

Methods, apparatuses, systems, computer program products, and/or the like for providing audio for a presentation are provided. Example methods, apparatuses, systems, computer program products, and/or the like are configured to perform acoustic rendering within respective listening spaces. For example, the audio of a presentation is acoustically rendered within a listening space so as to replicate the acoustic pressure distribution (e.g., sound distribution) from a virtual or phantom source. In some examples, the audio of the presentation is provided within the listening space so as to acoustically replicate the spatial distribution of the sound generated by the virtual or phantom source within the listening space.

These characteristics as well as additional features, functions, and details of various embodiments are described below. The claims set forth herein further serve as a summary of this disclosure.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A, 1B, and 1C illustrate an example listening space system, in accordance with an example, with each of FIGS. 1A, 1B, and 1C illustrating respective presentations of different presentation classes;

FIG. 2 is a flowchart illustrating processes, steps, procedures, and/or operations for providing audio of a presentation, in accordance with an example; and

FIG. 3 provides a block diagram of an example speaker control apparatus, in accordance with an example.

### DETAILED DESCRIPTION

The various examples now will be described more fully hereinafter with reference to the accompanying drawings, in which some, but not all embodiments are shown. Indeed, various embodiments may be embodied in many different forms and should not be construed as limited to the examples set forth herein; rather, these examples are provided so that this disclosure will satisfy applicable legal requirements. Like numbers refer to like elements throughout.

### General Overview

An audio system is configured to provide audio for a presentation. For example, an audio system may provide the audio of a conference call (e.g., a video conference, an audio conference, etc.), a live-streamed event, or the like. However, many conventional audio systems provide audio from multiple sources in the same manner. Notably, a conventional audio system tends to not replicate the acoustic pressure distribution of a virtual or phantom source.

The present disclosure provides listening space systems, speaker control apparatuses of listening space systems, and corresponding methods for providing a presentation within a listening space where the audio of the presentation is provided so as to synthesize an acoustic pressure distribution within the listening space that replicates the acoustic pressure distribution of a virtual or phantom source that is only virtually positioned within the listening space. For example, the virtual or phantom source may be a remote participant of a video conference that is being displayed within the listening space. Thus, various embodiments provide technical improvements in the field of acoustic rendering.

### Example Listening Space System

In various examples, speaker arrangement data for a listening space is obtained and receiver data is determined that corresponds to receivers within the listening space for a presentation to be presented within the listening space. The term “receiver” refers to a detector of acoustic pressure or sound positioned within a listening space. In general, the receivers are the cars of listeners but may include, in some examples, audio capture devices, such as microphones.

The term “speaker arrangement data” refers to data, metadata, and any associated instructions that indicates and/or provides respective locations of speakers or speaker arrays, configurations of speakers or speaker arrays, orientations of speakers or speakers arrays, geometries of speakers or speaker arrays (e.g., three-dimensional models (including computer-aided design (CAD) data) of the exterior speaker surface, including an indication of the surfaces that define the speaker diaphragms), respective frequency responses of speakers or speaker arrays, and/or other information characterizing the speakers or speaker arrays disposed within the listening space and the quantity or number of speakers within the listening space. The term “receiver data” indicates and/or provides the quantity or number of receivers within the listening space, the location of the receivers within the listening space, and/or the orientation of the receivers within the listening space.

Various example listening space systems use at least a portion of speaker arrangement data and at least a portion of receiver data to determine a particular presentation class for a presentation. The term “presentation” refers to a particular instance of provided audio, and possibly video and audio, for an event within a listening space. Some non-limiting examples of “events” include conference calls, streamed events such as talks, panel discussions, concerts, movie or film presentations, television presentations, streaming presentations, theatrical presentations, and/or the like.

The term “presentation class” provides a classification of how the audio for the presentation is to be provided within the listening space. For example, a particular presentation class may be used to select an algorithm used to determine how the audio is provided within the listening space for the presentation.

In some instances, a particular presentation class indicates whether the listening space system is receiver heavy, balanced, or speaker heavy for the presentation. The listening space system is a “receiver heavy system” when the quantity or number of receivers within the listening space is greater than the quantity or number of speakers. The listening space system is a “balanced system” when the quantity or number of receivers within the listening space is equal to the quantity or number of speakers within the listening space. The listening space system is a “speaker heavy system” when the quantity or number of receivers within the listening space is less than the quantity or number of speakers within the listening space.

Presentation solver instructions that are specific to the particular presentation class are accessed and executed by listening space systems to determine presentation data. As detailed elsewhere herein, the presentation data includes a velocity distribution uₛ corresponding to the speaker diaphragms of the speakers, respective frequency-dependent coefficient matrices [Λ]_{ω} for an array or set of representative audible frequencies, and/or other information used to operate the speakers or speaker arrays within the listening space to replicate the acoustic pressure distribution of one or more virtual or phantom sources of a presentation. For example, the presentation solver instructions are configured to, when executed by one or more processors, determine the presentation data based on the receiver data, the speaker data, and, in some examples, the source information. At least one of the speakers within the listening space is controlled to provide at least a portion of the audio of the presentation in accordance with the determined presentation data.

In various examples, the audio of the presentation is provided by a listening space system so as to replicate the acoustic pressure distribution of a virtual or phantom source that is only virtually positioned within the listening space. For example, the presentation may be a video conference occurring between two remote participants and a group of listeners positioned within a conference room listening space. A video monitor positioned in the listening space displays video corresponding to a first remote participant on the left portion of the video monitor and video corresponding to second remote participant on the right portion of the video monitor.

The portion of the audio corresponding to the first remote participant (e.g., when the first participant speaks) is provided via the speakers within the listening space such that it sounds to listeners within the listening space that the first remote participant is located on the left side of the listening space. Similarly, the portion of the audio corresponding to the second remote participant is provided via the speakers within the listening space such that is sounds to listeners within the listening space that the second remote participant is located on the right side of the listening space. Thus, the spatial distribution of the acoustic pressure of the presentation may be acoustically rendered within the listening space so as to replicate the spatial distribution of the sound generated by the virtual or phantom sources (e.g., the remote video conference participants as displayed on the video monitor). In various examples, the spatial distribution of the acoustic pressure of the presentation may be acoustically rendered within the listening space to provide an arbitrary spatial distribution of the sound generated by a virtual or phantom source.

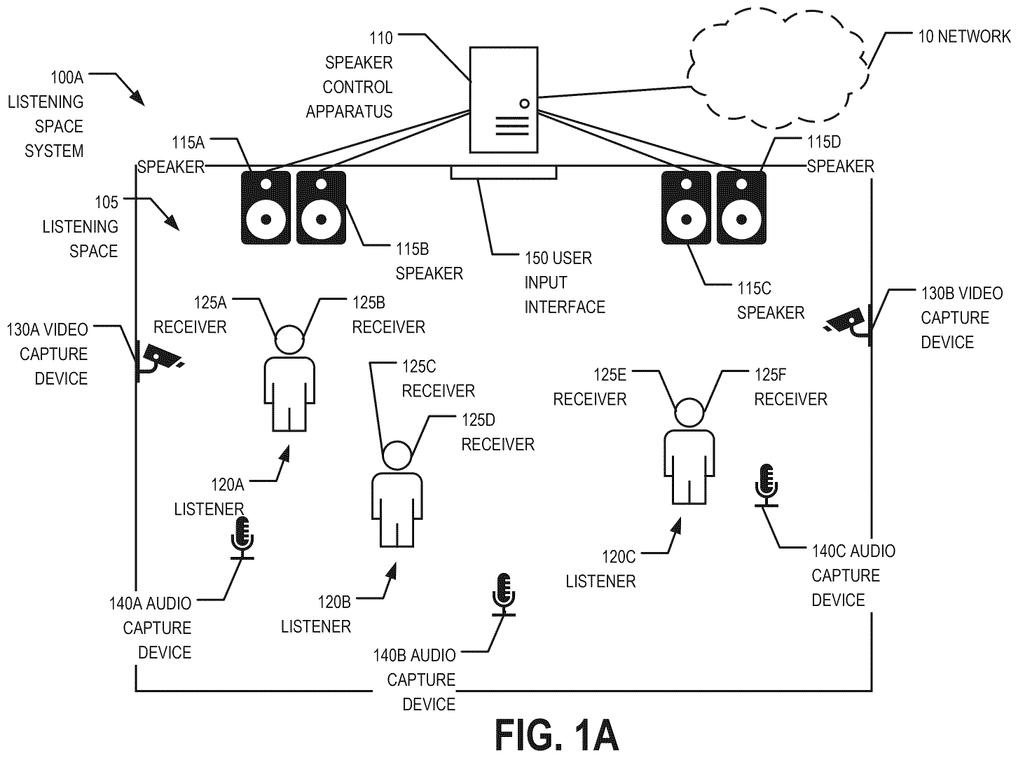

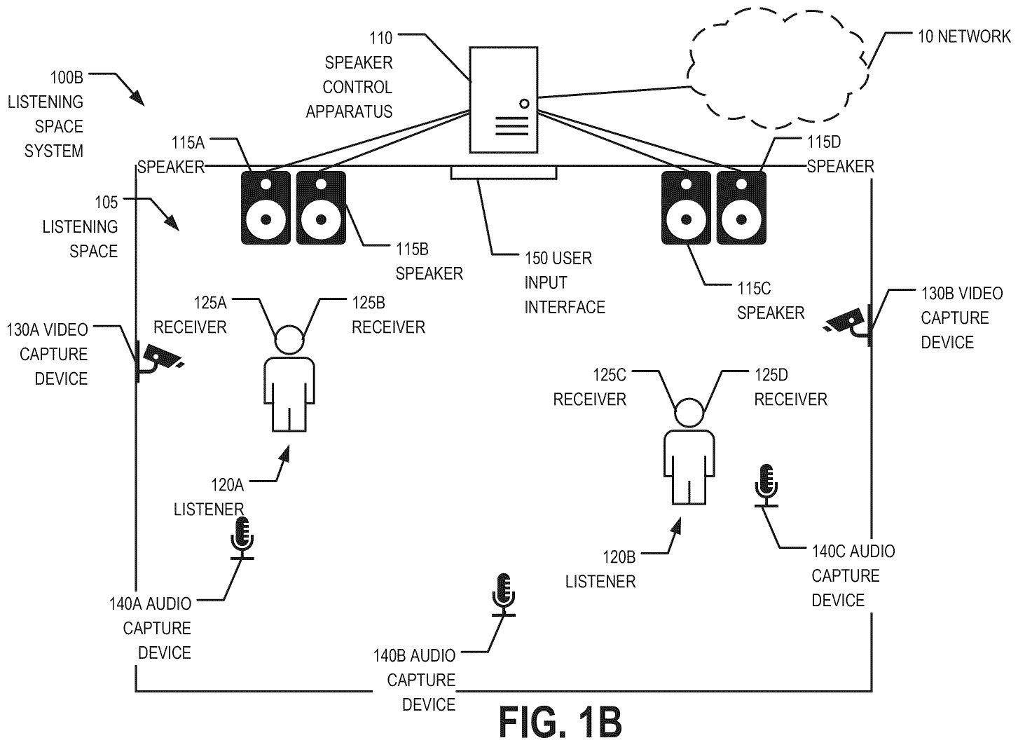

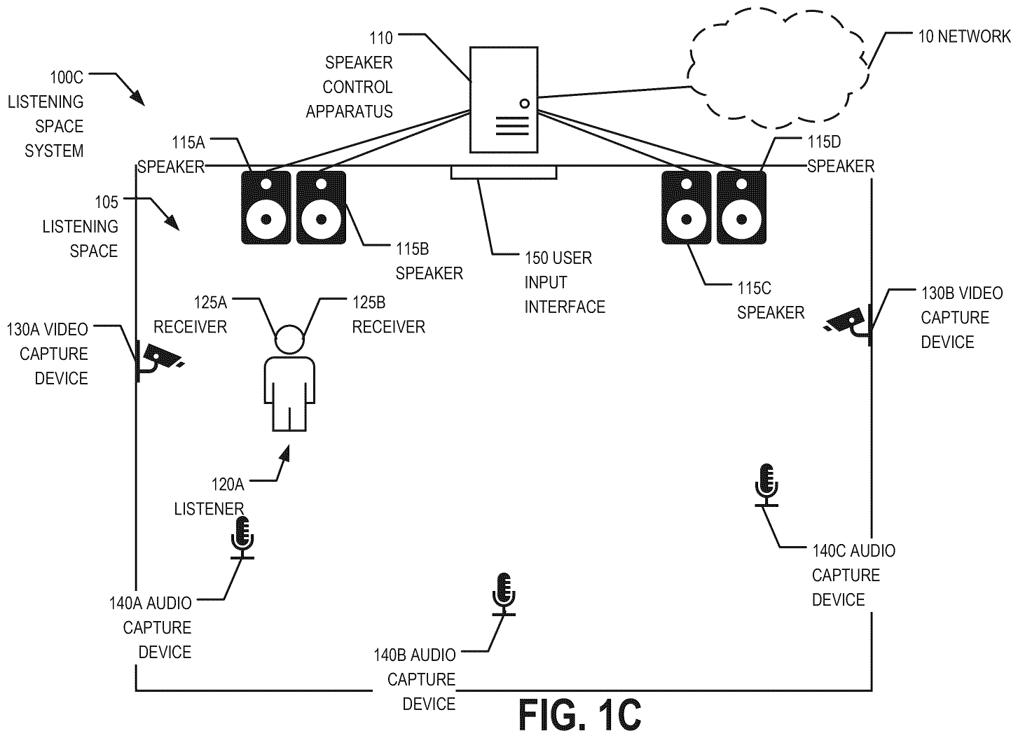

FIG. 1A-1C depict an example listening space system 100 (e.g., 100A, 100B, 100C) positioned within a listening space 105. The depicted listening space 105 may be a room, conference room, auditorium, concert hall, theater, outdoor space, and/or the like. One or more speakers 115 (e.g., 115A, 115B, 115C, 115D) are located within the listening space 105. The speakers 115 may be individual speakers, part of one or more speaker arrays, and/or a combination thereof. The speakers 115 may be installed and/or mounted within the listening space 105, (temporarily) positioned within the listening space 105, and/or the like.

In one example, the one or more speakers 115 comprise at least two individual speaker drivers and/or speakers that can be independently controlled. A speaker driver (or transducer) is configured to convert an electrical signal into an audio signal by mechanically moving air (e.g., via use of the speaker diaphragm) to generate the audio signal.

The speakers 115 are controlled by a speaker control apparatus 110. The speaker control apparatus 110 includes, and/or is configured to control, speaker drivers coupled to the speakers 115. For example, the depicted speaker control apparatus 110 is configured to control the operation of the speakers 115 to cause the speakers to generate sound within the listening space 105.

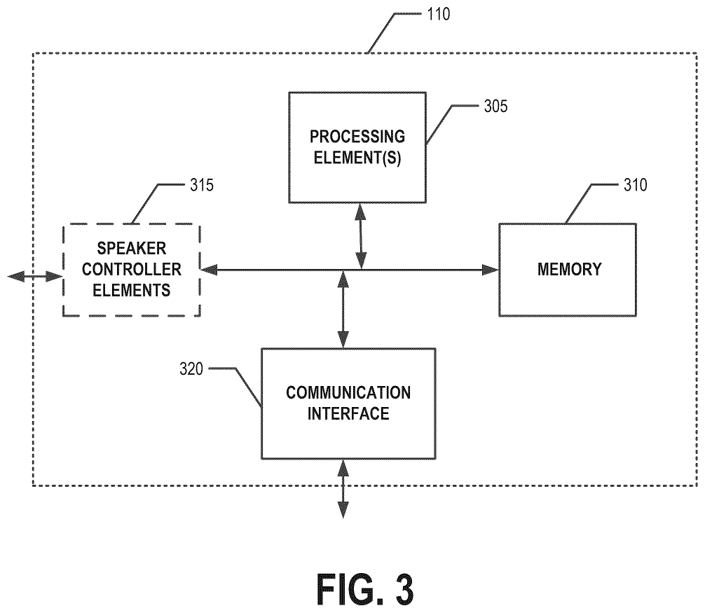

The speaker control apparatus 110 is a computer such as a server, desktop computer, laptop, tablet, computer circuitry, and/or the like that includes and/or is configured to control one or more speaker drivers. For example, as described in more detail with respect to FIG. 3, the speaker control apparatus 110 comprises one or more processors, at least one memory, a communication interface for communicating via one or more wired and/or wireless networks, and/or the like.

The depicted speaker control apparatus 110 is coupled to a user input interface 150 and/or a video monitor or display disposed within the listening space 105. The user input interface 150 is configured to display a virtual or phantom source of audio and may comprise a touchscreen, hard or soft keyboard, mouse, and/or other user input device. The speaker control apparatus 110 is in communication (e.g., via a communication interface) with a network 10, such as the Internet, an intranet, and/or the like. The speaker control apparatus 110 is configured to receive a presentation (e.g., a video conference, an audio/video file, an audio/video stream, and/or the like) via the network 10.

The speaker control apparatus 110 stores speaker arrangement data and/or is configured to determine speaker arrangement data indicating the location, geometry, and orientation of the speakers 115 within the listening space 105. In one example, the speaker control apparatus 110 is hard coded with speaker arrangement data indicating the location, geometry, and orientation of the speakers 115 within the listening space 105. The speaker control apparatus 110 may be further configured to store one or more preset arrangements for the listening space that indicate a number and location of receivers and a number, respective locations, respective geometries, and respective orientations of speakers 115 within the listening space 105 for a particular configuration of the listening space 105 (e.g., a particular set up of furniture, chairs or receiver positions, expected active user input interface positions, etc.). The stored one or more preset arrangements for the listening space may include at least a portion of presentation data corresponding to the particular configuration of the listening space 105 that has been pre-computed (e.g., computed prior to the presentation) and stored for future use.

The speaker control apparatus 110 may be disposed in communication with one or more sensors (e.g., video capture devices, audio capture devices, radio-frequency positioning beacon sensors, and/or the like) and configured to determine speaker arrangement data based on sensor signals received from the one or more sensors. For example, the speaker control apparatus 110 is configured to determine the speaker arrangement data via an audio calibration process (e.g., performed prior to the beginning of the presentation, at the beginning of the presentation, during the presentation, and/or the like).

The depicted listening space system 100 comprises various components (e.g., audio capture devices 140, video capture devices 130, etc.) that are configured to capture data that may be used to determine receiver data. The captured data may indicate a number of listeners 120 (e.g., 120A, 120B, 120C as shown in FIGS. 1A, 1B, and 1C respectively) located within the listening space 105. In the depicted examples, each listener 120A, 120B, and 120C is treated as a pair of receivers (e.g., 125A-B, 125C-D, 125E-F) corresponding to the listener's ears that are spatially coupled to one another. In other embodiments, a particular listener may be defined by a single receiver (e.g., where a listener is an audio capture device).

The captured data may be used to determine a quantity or number of receivers within the listening space 105 at a time corresponding to a presentation (e.g., right before the presentation, during the presentation, etc.). The captured data may also be used to determine the location of the receivers and/or the orientation of the receivers within the listening space at the time corresponding to the presentation.

FIGS. 1A, 1B, and 1C depict two video capture devices 130 (e.g., 130A, 130B) located within the listening space 105. In other embodiments, more or fewer video capture devices may be used. The video capture device(s) 130 may be a camera that is configured to capture images and/or video and provide the images and/or video to the speaker control apparatus 110 or other computing entity (via a wired and/or wireless connection, network 10, and/or the like). The speaker control apparatus 110 processes, analyzes, and/or provides the images and/or video as input to a machine learning-trained program/module to determine the receiver data and/or a portion thereof. The video capture devices 130 may be configured to capture visual images/video, infrared images/video, and/or the like.

In some examples, the video capture devices 130 may be part of a video conferencing system in the listening space 105 that is usable by video conference participants within the listening space 105 to communicate with remote participants. Thus, the video capture devices 130 may be configured to collect captured data used to determine receiver data associated with the listening space 105 and also more directly serve to support video conferencing functionality through in-conference video capture.

Video captured by the video capture devices 130 within the listening space 105 may be provided to a video monitor and/or display in another listening space (not shown) to support video conferencing or other event functionality. Turning specifically to the example depicted in FIG. 1A, video capture devices 130A and 130B may be configured to collect location data associated with listeners 120A, 120B, 120C who are potential sources of audio for this example. Such location data may be extracted as source data from the video captured by the video capture devices 130A-B within the listening space 105. The source data may also include a depth aspect (e.g., distance from a video capture device 130A to where a speaker/source 120A is located) that may be recreated (e.g., via appropriate source delays) by a remote listening space system (not shown) within another listening space (not shown) when producing corresponding audio generated by the source (e.g., 120A).

Put more simply, the video capture devices 130A-B may be used to determine receiver data for the listening space 105 and determine source data corresponding to potential sources (e.g., listeners 120A-C) within the listening space 105 for output to a remote listening space system (not shown) in another listening space. From the perspective of remote participants in the another listening space, potential sources from listening space 105 (e.g., listeners 120A, 120B, 120C) would be considered as virtual or phantom sources.

In addition to the characteristics discussed above, the term “source data” as used herein may include the respective locations and, possibly, orientation, of respective sources of audio of associated with a presentation (e.g., talkers, listeners, people who generate and/or could potentially generate audio as part of the presentation). The respective locations and/or orientations of the respective sources may be within respective source spaces (e.g., the respective rooms and/or the like where talkers or people who could generate audio as part of the presentation are located) and/or on a video monitor or display used to display a video of the presentation within the listening space 105.

Returning collectively to FIGS. 1A, 1B, and 1C, one or more audio capture devices 140 (e.g., 140A, 140B, 140C) are located within the listening space 105. The depicted audio capture devices 140A-C are microphones. The depicted audio capture devices 140 may include one or more individual audio capture devices, one or more audio capture device arrays, and/or a combination thereof.

The depicted audio capture devices 140 are configured to capture audio data and provide the audio data to the speaker control apparatus 110 or other computing entity (via a wired and/or wireless connection, network 10, and/or the like). The audio capture devices 140 may be configured to capture audio provided by participants located within the listening space as part of a video conference, conference call, and/or other presentation/event, in addition to being configured to capture audio that is configured for use in determining the receiver data. This dual-purpose functionality is similar to that discussed above in reference to video capture devices 130.

The audio data captured by the audio capture devices 140 and/or video data captured by the video capture devices 130 are processed, analyzed, and provided as input to a machine learning-trained program/module, and/or the like to determine the receiver data and/or a portion thereof. In various examples, the machine learning-trained program/module is trained to identify and/or determine the location of listeners 120 within the listening space 105 based on the captured audio and/or video data. In one example, the machine learning-trained program/module is trained to identify and/or determine the location and orientation of listeners 120 within the listening space 105 based on audio and/or video data. In other examples, the machine learning-trained program/module is trained to identify heads of listeners within the listening space and/or an orientation of the heads of listeners within the listening space based on captured audio and video data.

In still other examples, the machine learning-trained program/module is trained to identify locations of noise sources (e.g., people talking or making other noises, sources of stationary or non-stationary noise, reverberation, etc.) within the listening space and/or an orientation of noise sources (e.g., a direction someone is facing when talking or other noise vector orientation) within the listening space based on audio data and video data. The machine learning-trained program/module may be trained to use a combination of audio data and video data to determine and/or identify the location and/or orientation of listeners within the listening space. Such machine learning-trained program/module may also be trained to determine locations and/or orientations of receivers associated with the listeners (e.g., the listeners' ears).

The machine learning-trained program or module may include a neural network, deep neural network, convolutional neural network, and/or the like configured to determine and/or identify the location and/or orientation of listeners and/or receivers within the listening space based on audio data and/or video data. The machine learning-trained program or module may include computer vision models, source separation models, source localization models, audio denoising models, and the like.

Audio captured by the audio capture devices 140 within the listening space 105 may be provided by one or more speakers in another (remote) listening space (e.g., virtual or phantom sources). Audio of such remote participants is output by user input interface 150 using information and/or data corresponding to the location of the one or more remote sources that generated the audio, which was possibly determined based on the video captured by video capture devices and audio capture devices of such remote listening space system. Similarly, the audio captured by the depicted audio capture devices 140 is provided along with video captured by the depicted video capture devices 130 to a remote listening space system (not shown) to support configuration of the presentation in the remote listening space. In such example, speakers (e.g., listener 120A) would be considered virtual or phantom sources relative to such remote listening space system.

Chairs, the floor, and/or other furniture/items within the listening space 105 may comprise sensors (e.g., pressure sensors, heat sensors, accelerometers, gyroscopes, compasses, position senses, and/or the like) that are configured to capture occupancy data and provide the occupancy data to the speaker control apparatus 110 or other computing entity. For example, a chair may include a pressure sensor configured to detect when a listener 120 sits in the chair. The chair may further include a compass that is configured to determine the orientation of the chair. The chair may further include a radio receiver, transmitter, and/or transceiver such that the location of the chair within the listening space may be determined using a radio-based positioning technique that employs one or more radio nodes and/or beacons within or near the listening space 105. The data indicating whether the chair is occupied, the orientation of the chair, and/or the location of the chair within the listening space 105 may then be provided to the speaker control apparatus 110 and/or other computing entity for use in determining receiver data.

Listeners 120 within the listening space 105 may carry on their persons listener devices such as smartphones, ID badges, and/or the like that may comprise radio frequency ID (RFID) or short-range radio communication (e.g., Bluetooth, near field communication (NFC), ultra-wideband (UWB)) components and/or interfaces. The listener devices may interact and/or interface with the speaker control apparatus 110 and/or one or more radio nodes or beacons within or near the listening space 105. Based on data obtained through interaction of the listener devices with the speaker control apparatus 110 and/or one or more radio nodes or beacons within or near the listening space 105, the speaker control apparatus 110 may determine when listeners enter or exit the listening space 105, where the listeners are located within the listening space 105, and/or the like.

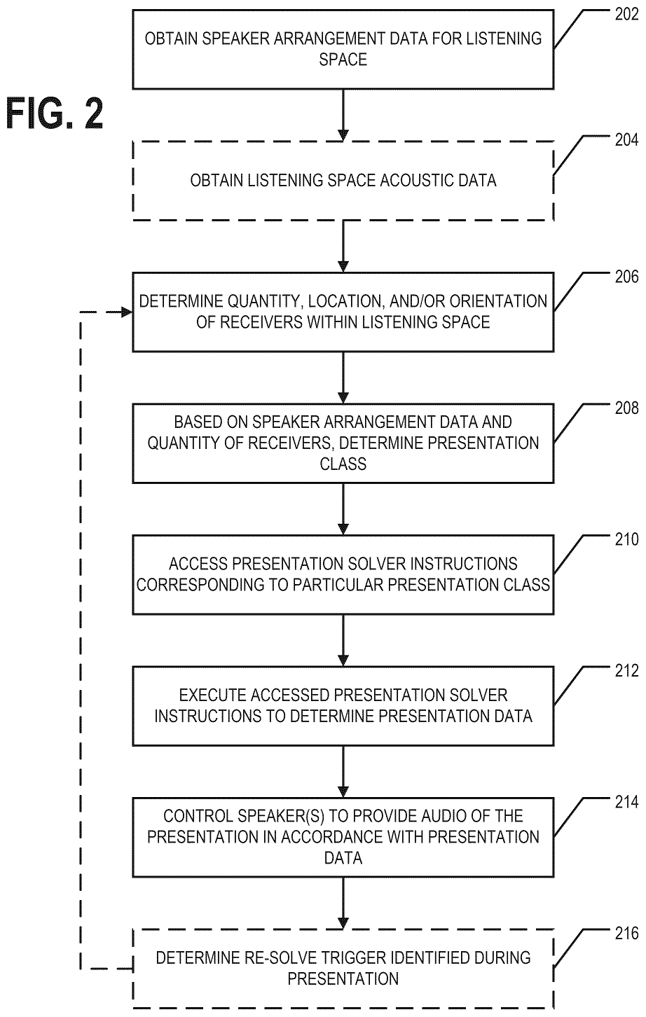

Though not pictured in FIGS. 1A, 1B, and 1C, it should be understood that various furniture and/or other items may be present in the listening space 105. For example, the listening space 105 may include tables, chairs, bookshelves, additional video monitors or displays, credenzas, carpets, acoustic dampers or enhancing devices, and/or the like. Such furniture may impact the location of listeners 120 within the listening space 105. Additionally, such furniture may act as absorbers and/or otherwise affect the acoustics of the listening space 105. Accordingly, the capability of example listening space systems discussed herein to identify the presence and location of such furniture and/or other items may be useful as listening space acoustic data used to train or refine the machine learning-trained programs or modules discussed above and/or to determine receiver data as discussed in connection with FIG. 2 below.

Each of FIGS. 1A, 1B, and 1C illustrate an example scenario of a different presentation class. In various instances, the presentation information for different presentation classes is determined using different algorithms or presentation solver instructions. In other words, the algorithm or presentation solver instructions used to determine the presentation information for a presentation may be particular to and/or determined based on the presentation class corresponding to the presentation.

FIG. 1A illustrates an example listening space system 100A with four speakers 115A-D and three listeners 120A-C located within the listening space 105. Each of the listeners 120A-C has two cars, such that listening space system 100A includes six receivers 125A-F within the listening space 105. As the quantity or number of receivers 125A-F within the listening space 105 is greater than the quantity or number of speakers 115A-D within the listening space, the listening space system 100A is a receiver heavy system. In other words, the listening space system 100A corresponds to a presentation class referred to herein as the receiver heavy class.

FIG. 1B illustrates a listening space system 100B with four speakers 115A-D and two listeners 120A-B located within the listening space 105. Each of the listeners 120A-B has two cars, such that the listening space system 100B includes four receivers 125A-D within the listening space 105. As the quantity or number of receivers 125A-D within the listening space 105 is equal to the quantity or number of speakers 115A-D within the listening space, the listening space system 100B is a balanced system. In other words, the listening space system 100B corresponds to a presentation class referred to herein as the balanced class.

FIG. 1C illustrates a listening space system 100C with four speakers 115A-D and one listener 120A located within the listening space 105. As the listener 120A has two cars, the listening space system 100C includes two receivers 125A-B. As the quantity or number of receivers 125A-B within the listening space 105 is less than the quantity or number of speakers 115A-D within the listening space 105, the listening space system 100C is a speaker heavy system. In other words, the listening space system 100C corresponds to a presentation class referred to herein as the speaker heavy class.

### Example of Providing Audio for a Presentation

FIG. 2 provides a flowchart illustrating various processes, procedures, operations, and/or the like for providing audio for a presentation within the listening space 105. Starting at block 202, speaker arrangement data for the listening space 105 is received. For example, the speaker control apparatus 110 (e.g., one or more processors thereof) obtains speaker arrangement data for the listening space 105. The speaker arrangement data of the depicted embodiment includes an indication of the quantity or number of speakers, speaker array speaker elements, and/or the like within the listening space 105 and the location and/or orientation of the speakers, speaker array speaker elements, and/or the like within the listening space 105.

The depicted speaker arrangement data includes data about the frequency response and physical geometry of one or more speakers 115 and is stored as part of speaker metadata corresponding to a respective one or more speakers 115. For example, the speaker control apparatus 110 of FIG. 1A monitoring listening space 105 may be configured to store speaker metadata that includes information regarding speakers 115A-D or speaker arrays disposed within the listening space, including a physical geometry of a speaker (e.g., 115B) such as a three-dimensional model of the exterior speaker surface including the speaker diaphragm.

The speaker arrangement data is configured to be accessed by one or more processing elements 305 (see FIG. 3) of the speaker control apparatus 110 from a memory 310 of the speaker control apparatus 110. The speaker arrangement data may also be received as user input provided via the user input interface 150 or through the communication interface 320 of the speaker control apparatus 110 via network 10, and/or the like. In various instances, the speaker control apparatus 110 is configured to use the speaker arrangement data and/or portions thereof to determine a presentation class corresponding to a presentation and to determine the presentation information for a presentation.

At block 204, listening space acoustic data is received. The “listening space acoustic data” comprises information and/or data detailing various acoustic scatterers within the listening space (e.g., furniture, architectural and/or decorative elements, acoustic enhancing or dampening elements, and/or the like that amplify, dampen, or scatter sound, or affect audio perception within or throughout a listening space), boundary data for the listening space, and/or the like. In one instance, the data detailing acoustic scatterers (e.g., furniture, architectural features, and/or the like within the listening space 105) within the listening space may indicate a location of an acoustic scatterer and scattering properties of the acoustic scatterer.

In another instance, boundary data for the listening space may indicate the locations of boundary walls of the listening space, acoustic dampening and/or reflective qualities of the boundary walls, and/or the like. A boundary wall may comprise a wall at least partially defining the listening space 105, the floor at least partially defining the listening space 105, and/or the ceiling at least partially defining the listening space 105.

The listening space acoustic data may be received by one or more processing elements 305 of the speaker control apparatus 110. In various examples, the one or more processing elements 305 of the speaker control apparatus 110 are configured to access the listening space data and/or portions thereof from a memory 310 of the speaker control apparatus 110, receive the listening space acoustic data and/or portions thereof as user input provided via the user input interface 150, receive the listening space acoustic data and/or portions thereof through the communication interface 320 of the speaker control apparatus 110 via network 10, and/or the like.

At block 206, receiver data corresponding to a presentation is received and/or determined. The speaker control apparatus 110 determines and/or receives (e.g., via the one or more processing elements 305 thereof) receiver data corresponding to a presentation. In some examples, sensor data captured by one or more sensors within the listening space, video capture devices 130, audio capture devices 140, and/or the like may be analyzed to determine receiver data for the presentation. In one instance, receiver data may be received via the user input interface 150. The depicted receiver data indicates a quantity and/or number of receivers 125 within the listening space 105, the location of one or more receivers 125 within the listening space 105, the orientation of one or more receivers 125 within the listening space 105, and/or the like.

The receiver data is determined, at least in part, based on the data captured by sensors, video capture devices 130, and/or audio capture devices 140 within the listening space 105. In some instances, the receiver data is determined, at least in part, based on user input received via the user input interface 150. For example, the speaker control apparatus 110 may store a receiver data application configured to process sensor data captured by one or sensors associated with the listening space, audio data captured by one or more audio capture devices 140, video data captured by one or more video capture devices 130 and/or information received via user input to determine receiver data (e.g., number/quantity, locations, orientations, and/or the like of receivers within the listening space). In various examples, the receiver data application is configured to receive sensor data, audio data, video data, and/or indications of user input via respective application program interfaces (APIs) thereof.

In an example, the receiver data is determined, at least in part, based on the listening space acoustic data. For example, the receiver data may be determined by assuming a listener 120 (associated with two receivers 125A-B) is sitting in each chair indicated by the listening space acoustic data.

In still other examples, the receiver data is determined, at least in part, based on machine learning models and/or clustering algorithms that are trained to predict receiver data using a corpus of training data collected over one or more defined periods from sensors within the listening space. Such sensors may include, without limitation, video capture devices 130, audio capture devices 140, furniture position sensors (e.g., accelerometers, gyroscopes, pressure sensors, location beacons) and furniture orientation sensors (e.g., gyroscopes, etc.), acoustic scatterer data, and the like. In various examples, the machine learning-trained program or module may include a neural network, deep neural network, convolutional neural network, and/or the like configured to determine and/or identify the location and/or orientation of listeners and/or receivers within the listening space based on audio data, video data, and/or other sensor data provided by sensors within the listening space.

At block 208, based on the speaker arrangement data and the receiver data, the speaker control apparatus 110 (e.g., via the processing element 305 thereof) determines and/or identifies a particular presentation class corresponding to the presentation. In some instances, the speaker control apparatus 110 determines and/or identifies a particular presentation class from a plurality of presentation classes corresponding to the presentation based at least in part on the receiver data corresponding to the presentation and the speaker arrangement data for the listening space 105. The particular presentation class is determined and/or identified based on a comparison of the quantity and/or number of speakers 115 within the listening space 105 and the quantity and/or number of receivers 125 within the listening space 105.

Speaker control apparatus 110 described with respect to FIGS. 1A, 1B, and 1C identifies and/or selects the particular presentation class from a plurality of presentation classes. The plurality of presentation classes include a receiver heavy class, a balanced class, and a speaker heavy class. When the receiver data and the speaker arrangement data indicate that the quantity and/or number of receivers 125 within the listening space 105 is greater than the quantity and/or number of speakers 115 within the listening space 105, the receiver heavy class is identified, determined, and/or selected as the particular presentation class (e.g., as shown in FIG. 1A). When the receiver data and the speaker arrangement data indicate that the quantity and/or number of receivers 125 within the listening space 105 is equal to the quantity and/or number of speakers 115 within the listening space 105, the balanced class is identified, determined, and/or selected as the particular presentation class (e.g., as shown in FIG. 1B). Finally, when the receiver data and the speaker arrangement data indicate that the quantity and/or number of receivers 125 within the listening space 105 is less than the quantity and/or number of speakers 115 within the listening space 105, the speaker heavy class is identified, determined, and/or selected as the particular presentation class (as shown in FIG. 1C).

At block 210, presentation solver instructions are accessed that correspond to the determined and/or identified particular presentation class. In various examples, presentation solver instructions comprise program code and/or computer-executable instructions configured to determine presentation data based on speaker arrangement data, receiver data, and possibly listening space acoustic data and/or source data. For example, the presentation solver instructions are configured to determine a velocity distribution uₛ corresponding to the speaker diaphragms of the speakers, respective frequency-dependent coefficient matrices [Λ]_{ω} or an array or set of representative audible frequencies, and/or other information used to operate the speakers or speaker arrays within the listening space to replicate the acoustic pressure distribution of one or more virtual or phantom source for a corresponding presentation class. For example, the memory of the speaker control apparatus 110 may store computer-executable instructions that are specific to each presentation class of the plurality of presentation classes. The one or more processors of the speaker control apparatus 110 are configured to access the presentation solver instructions corresponding to the particular presentation class.

At block 212, the speaker control apparatus 110 (e.g., the one or more processors of the speaker control apparatus 110) executes the presentation solver instructions corresponding to the particular presentation class to determine presentation data corresponding to the presentation. In various examples, the respective presentation solver instructions for each presentation class use a different algorithm, technique, and/or architecture for determining the presentation data.

In various examples, at least a portion of the presentation data for a particular configuration of the listening space is stored (e.g., in memory 310 of the speaker control apparatus 110) as a preset arrangement (e.g., corresponding to a particular number and location of receivers and a particular number, respective locations, respective geometries, and respective orientations of speakers 115 within the listening space 105). For example, the speaker control apparatus 110 may have previously executed the presentation solver instructions (and/or at least a portion thereof) and stored the resulting presentation data to be accessed when the configuration of the listening space 105 matches the preset arrangement. The preset arrangement may be accessed from memory 310. In another example, the speaker control apparatus 110 may access presentation data pre-computed for two or more preset arrangements and interpolate between the two or more preset arrangements to determine presentation data.

In various examples, at least a portion of the presentation data is determined for a particular live presentation. For example, the presentation data or portion thereof may be determined in real time with respect to the occurrence of a live presentation and is thus not determined based on preset arrangements.

In various examples, the presentation data comprises a velocity distribution uₛ corresponding to the speaker diaphragms of the speakers 115. For example, the presentation data comprises respective velocity distribution uₛ corresponding to speaker diaphragms of the speakers 115 with each velocity distribution uₛ corresponding to a frequency (e.g., an audible frequency).

Given acoustic scatterers within the listening space 105, as detailed by the listening space acoustic data and/or receiver data (e.g., the bodies of the listeners may be assumed to be acoustic scatterers), for a given position z within the three-dimensional space of the listening space 105, the pressure at the position z is given by the Kirchoff-Helmholtz integral equation ϵ(z)p(z)=∫G∇p·ds−∫p∇G·dS, where Vx is a three dimensional vector that is the gradient of x and dS is the derivative of a surface element S of a surface of an acoustic scatter within the listening space. The integrals are defined to occur over all the domain boundaries and acoustic scatterers within the listening space 105. Additionally, e is the solid angle into the listening space 105 evaluated at position z. The surface normal eₛ, where dS=eₛdS, points into the bodies of the acoustic scatterers.

Generally, the solid angle ϵ at position z is determined by

$$ε ( z ) = \{ \begin{matrix}4 π & z ∉ S ( y ) \\ 2 π & z ∈ S ( y )\end{matrix} ,$$

where y is a position on a surface within the listening space 105. For example, y could be a position on a surface of a speaker 115, surface of an acoustic scatterer within the listening space 105, surface of a wall, ceiling, or floor of the listening space 105, and/or other surface within the listening space 105. For low frequencies and positions z on scattering elements, the numerical approximation

$${lim}_{z \to {y}_{m}} ϵ ( z ) \to {ϵ}_{m} \approx \vert \int ∇ G ( y , {y}_{m} ; 0 ) \cdot dS \vert$$

is used to determine the solid angle ϵ at position z.

The free-space Green's function for an audible frequency corresponding to wave vector k is given by

$$G ( y , z ; k ) = \frac{{e}^{ik \vert y - z \vert}}{\vert y - z \vert} .$$

Using a boundary element method, the boundary can be divided into a mesh of N_{S} elements each characterized by length l≤λ/8, where λ is the wavelength corresponding to the respective audible frequency. It is then assumed that the pressure p and the pressure gradient ∇p are both constant over the element such that ϵ(z)p(z)=iωρ₀Σⱼ₌₁^{N}^{_{S}}uⱼ∫G(yⱼ, z; k)dSⱼ−Σₙ₌₁^{N}^{ₛ}pₙ∫∇G(yₙ, z; k)·dSₙ, where ∇p(y)·dS=iωρ₀u(y), where u(y) is the normal velocity distribution of the surface at position y on the surface, ω is the audible frequency, and ρ₀ is ambient air density. The steady state, harmonic time dependence is given as e^{-iωt}.

By taking the receiver position z to the centroid of each surface element of the boundary, ϵₘpₘ=iωΣⱼ₌₁^{N}^{_{S}}uⱼρ₀∫G(yⱼ, yₘ; k)dSⱼ−Σₙ₌₁^{N}^{ₛ}pₙ∫∇G(yₙ, yₘ; k)·dSₙ or [ϵ]pₛ=iω[N]uₛ−[M]pₛ, where pₛ and uₛ are N_{S}×1 vectors and [ϵ], [N], and [M] are N_{S}×N_{S}. This can be rewritten as pₛ=[Λ]uₛ, where the frequency-dependent coefficient matrix [Λ]=iω([ϵ]+[M])₋₁[N] is a N_{S}×N_{S} matrix that is invariant to the surface velocity distribution uₛ and effectively accounts for the acoustical artifacts (scattering, diffraction, reflection, and/or the like) of the acoustic scatterers, listeners, and/or boundaries within the listening space 105.

For static, non-changing listening space acoustic data and/or receiver data, the frequency-dependent coefficient matrix [Λ] can be determined once for each audible frequency being considered and stored (e.g., in memory of the speaker control apparatus 110). For example, a respective frequency-dependent coefficient matrix [Λ] is determined for an array or set of representative audible frequencies and stored (e.g., in memory of the speaker control apparatus 110), in an example. In an example, the presentation data comprises the respective frequency-dependent coefficient matrices [Λ]_{ω} for the array or set of representative audible frequencies.

Thus, ϵ(z)p(z)=(iωnᵣ^{T}−mᵣ^{T}[Λ])uₛ, where the j-th element of the vector nᵣ is (nᵣ)ⱼ=ρ₀∫G(yⱼ, z; k)dSⱼ and the j-th element of the vector mᵣ is (mᵣ)ⱼ=∫∇G(yⱼ, z; k)·dSⱼ. This equation can then be solved for the surface velocity distribution of the diaphragms of the speakers 115 based on a desired pressure p(z). In particular, the desired pressure p(z) is configured to replicate the spatial distribution of the acoustic pressure within the listening space 105 generated by the virtual or phantom source.

In an example, the velocity distribution uₛ is not continuous over the surfaces and is restricted to the surface elements corresponding to the speaker diaphragms. Thus, uₛ=[Φ]η, where [Φ] is a parse matrix with at most a single unity coefficient per row, such that

$${( Φ )}_{ij} = \{ \begin{matrix}1 & i = element of speaker j \\ 0 & otherwise\end{matrix} .$$

The matrix [Φ] is a matrix of dimension N_{S}×N_{d}, where N_{d} is the number of speakers. Moreover, the j-th element of the speaker velocity vector η is (η)ⱼ is the to be determined velocity of the j-th speaker. In various examples, the speaker velocity vector η_{ω} is frequency dependent such that respective frequency-dependent speaker velocity vectors η_{ω} are determined for the array or set of representative audible frequencies.

The algorithm and/or architecture implemented to solve for the speaker velocity vector η (and/or respective frequency-dependent speaker velocity vectors η_{ω}) differs between the presentation classes. For example, the computational framework and/or the computer-executable instructions for determining the speaker velocity vector n (and/or respective frequency-dependent speaker velocity vectors n_{ω}) are specific to the particular presentation class corresponding to the presentation. For example, it is possible to write η as η=[Γ] pᵣ, where the format of the coefficient matrix [Γ] is dependent on the presentation class and is determined as part of the presentation data by the presentation solver instructions corresponding to the particular presentation class.

### Receiver Heavy Class

When the particular presentation class corresponding to a presentation is the receiver heavy class (e.g., there are more receivers 125 in the listening space 105 than speakers 115), a least squares minimization is used to determine the speaker velocity vector η (and/or respective frequency-dependent speaker velocity vectors n_{ω}), in an example. In particular, when the number of receivers is Nᵣ (with Nᵣ>N_{d}), the pressure at the locations of the receivers 125 is given by the Nᵣ×1 vector pᵣ. The equation ϵ(z)p(z)=(iωnᵣ^{T}−mᵣ^{T}[Λ])uₛ can then be written as ϵᵣpᵣ=[Σ]η, where [Σ]=(iω[nᵣ]^{T}−[mᵣ]^{T}[Λ])[Φ] is a non-square Nᵣ×N_{d} matrix. Additionally, the elements of the solid angle matrix [ϵ] are (ϵᵣ)ᵢⱼ=δᵢⱼ4π, where δᵢⱼ is the Kronecker delta function.

In various examples, an error residual vector R is defined such that R=|[ϵᵣ]pᵣ−[Σ]_{η}|². Differentiating the error residual vector R with respect to the unknown speaker velocity vector η and setting the derivative equal to zero provides

$$\frac{\partial R}{\partial η} = - {2 [ \sum ]}^{H} ( [ {ϵ}_{r} ] {p}_{r} - [ \sum ] η ) = 0.$$

This provides speaker velocity vector η=([Σ]^{H}[Σ])⁻¹[Σ]^{H}[ϵᵣ]pᵣ=[Γ]pᵣ, where [Σ]^{H} is the transpose of matrix [Σ]. Thus, [Γ]=([Σ]^{H}[Σ])⁻¹[Σ]^{H}[ϵᵣ].

In an example, the columns of the matrix [Σ] are linearly independent. For example, the matrix [Σ] is in row-reduced, echelon form (RREF), in an example. When the locations of the receivers remain constant (e.g., the receivers 125 are substantially not moving around in the listening space 105) the coefficient matrix [Γ] is constant and can be determined and stored (e.g., in memory). The coefficient matrix [Γ] is the pseudo or generalized inverse of [Σ].

In various examples, the presentation data comprises a coefficient matrix [Γ] and/or respective frequency-dependent coefficient matrices [Γ]_{ω} for an array or set of representative audible frequencies. For example, the presentation solver instructions corresponding to the receiver heavy class are configured to solve for the coefficient matrix [Γ]=([Σ]^{H}[Σ])⁻¹[Σ]^{H}[ϵᵣ] and/or respective frequency-dependent coefficient matrices [Γ]_{ω}=([Σ_{ω}]^{H}[Σ_{ω}])⁻¹[Σ_{ω}]^{H}[ϵᵣ] for an array or set of representative audible frequencies to determine the presentation data.

### Balanced Class

When the particular presentation class corresponding to a presentation is the balanced class (e.g., there are the same quantity or number of receivers 125 in the listening space 105 as speakers 115), the equation ϵᵣpᵣ=[Σ]η, can be re-written as η=[Σ]⁻¹[ϵᵣ]pᵣ. In particular, as Nᵣ=N_{d}, the matrix [Σ] is a square matrix of rank Nᵣ. Thus, the coefficient matrix [Γ] is defined as [Γ]=[Σ]⁻¹[ϵᵣ] when the presentation corresponds to the balanced class.

In various examples, the presentation data comprises a coefficient matrix [Γ] and/or respective frequency-dependent coefficient matrices [Γ]_{ω} for an array or set of representative audible frequencies. For example, the presentation solver instructions corresponding to the balanced class are configured to solve for the coefficient matrix [Γ]=[Σ]⁻¹[ϵᵣ] and/or respective frequency-dependent coefficient matrices [Γ]_{ω}=[Σ_{ω}]⁻¹[ϵᵣ] for an array or set of representative audible frequencies to determine the presentation data.

### Speaker Heavy Class

When the particular presentation class corresponding to a presentation is the speaker heavy class (e.g., there are fewer receivers 125 in the listening space 105 than speakers 115), a minimum norm technique is used to determine the speaker velocity vector η (and/or respective frequency-dependent speaker velocity vectors η_{ω}), in an example. In various examples, a solution for the speaker velocity vector η (and/or respective frequency-dependent speaker velocity vectors η_{ω}) that minimizes the norm of the speaker velocity vector |η|. The kinetic energy of the speakers is given by ½mₛ|η|², minimizing the norm of the speaker velocity vector |η| results in minimizing the kinetic energy of speakers. This provides the advantage of minimizing the energy needed to operate and/or drive the speakers, in an example.

Starting with [Σ]η₀=[ϵᵣ]pᵣ, where η₀ is a particular solution. In various examples, the matrix [Σ] is an RREF matrix of rank Nᵣ. This implies that there exists an η such that η=η₀−ζ, such that [Σ]ζ=0. This results in η=[Σ]^{H}σ, where σ=([Σ][Σ]^{H})⁻¹[ϵᵣ]pᵣ, where [Σ][Σ]^{H} is the Gram matrix. Thus, the coefficient matrix [Γ] is defined as [Γ]=[Σ]^{H}([Σ][Σ]^{H})⁻¹[ϵᵣ] when the presentation corresponds to the speaker heavy class.

In various examples, the presentation data comprises a coefficient matrix [Γ] and/or respective frequency-dependent coefficient matrices [Γ]_{ω} for an array or set of representative audible frequencies. For example, the presentation solver instructions corresponding to the speaker heavy class are configured to solve for the coefficient matrix [Γ]=[Σ]^{H}([Σ][Σ]^{H})⁻¹[ϵᵣ] and/or respective frequency-dependent coefficient matrices [Γ]_{ω}=[Σ_{ω}]^{H}([Σ_{ω}][Σ_{ω}]^{H})⁻¹[ϵᵣ] for an array or set of representative audible frequencies to determine the presentation data.

Returning to block 214 of FIG. 2, the speaker control apparatus 110 controls operation of speakers 115 to provide at least a portion of the audio of the presentation in accordance with and/or based at least in part on the presentation data. For example, the speaker control apparatus 110 may use the presentation data to determine how to drive the speakers 115 to cause the audio of at least a portion of the presentation to be provided.

For example, the speaker control apparatus 110 may adjust or modify one or more parameters of the speakers 115 to enable the speakers 115 to provide the audio of a presentation such that the audio replicates the acoustic pressure distribution of one or more virtual or phantom sources of a presentation. For example, the one or more parameters of the speakers 115 may be adjust and/or modified based on the respective frequency-dependent coefficient matrices [Λ]_{ω} for an array or set of representative audible frequencies and/or the like of the presentation data.

In various examples, the speaker control apparatus 110 receives content data. In various examples, the content data includes audio data that provides the audio of the presentation. For example, the speaker control apparatus 110 may use the presentation data to determine how to drive the speakers to cause the audio corresponding to the audio data to be provided within the listening space 105. In various examples, the content data further includes video data that corresponds to the audio data. For example, the video data may be configured to be displayed via a video monitor or display within the listening space 105. In various instances, the video data may include video of one or more people talking. The talking people may be the source of the audio corresponding to the audio data.

In various examples, the content data further includes presentation class data, source data (e.g., where one or more sources are located within an environment represented by the video data), metadata regarding the presentation, and/or the like. For example, audio capture devices located in a source space may capture audio data corresponding to the source space and video capture devices located in the source space may capture video data corresponding to the source space. The audio data and/or the video data may be processed to identify a location of one or more sources within the source space. The data identifying the location of the one or more sources within the source space may then be provided (e.g., as metadata and/or the like) to the speaker control apparatus 110 as part of the content data alongside the audio data and the video data.

In various examples, the speaker control apparatus 110 configured to control the operation of the speakers 115 within the listening space 105 receives content data that was generated and provided by a speaker control apparatus 110 associated with the source space. For example, the speaker control apparatus 110 configured to control the operation of the speakers 115 within the listening space 105 may be in electronic communication (e.g., via one or more wired and/or wireless networks 10) with another speaker control apparatus 110 that is associated with the source space. In an example, the speaker control apparatus 110 configured to control the operation of the speakers 115 within the listening space 105 is configured to generate content data including audio data captured by the audio capture devices 140 within the listening space 105 and/or video data captured by the video capture devices 130 within the listening space and provide the content data for receipt by the speaker control apparatus associated with the source space. For example, the speaker control apparatus associated with the source space may control operation of speakers located within the source space.

The speaker control apparatus 110 controls the speakers 115 to provide audio within the listening space 105 using at least a portion of the content data. For a speaker located at position x within the listening space 105, the pressure at receiver position zₙ is given by

$${p}_{r} ( {z}_{n} , t ) = \frac{δ ( t - \vert x - {z}_{n} \vert / {c}_{0} )}{\vert x - {z}_{n} \vert} ,$$

where δ(τ) is the Dirac delta function as a function of time τ, and c₀ is the speed of sound. The Fourier transform of the pressure at the receiver position yields the frequency domain, monopole, pressure source

$${p}_{r} ( {z}_{n} , ω ) = \frac{1}{\vert x - {z}_{n} \vert} {\int }_{- ∞}^{∞} δ ( t - \vert x - {z}_{n} \vert / {c}_{0} ) {e}^{i ω t} d t = \frac{{e}^{i ω {Δ}_{n}}}{\vert x - {z}_{n} \vert} ,$$

where the delay Δₙ=|x−zₙ|/c₀. The discrete per frequency vector of receiver pressures can then be written as pᵣ=[R⁻¹]ξ, where [R⁻¹] is a diagonal matrix that is independent of frequency such and

$${( {R}^{- 1} )}_{i j} = \frac{{δ}_{i j}}{\vert x - {z}_{i} \vert} ,$$

where δᵢⱼ is the Kronecker delta function. The components of vector (ξ)ⱼ=e^{iω}^{ₖ}^{Δ}^{ⱼ} are time delays in the frequency domain. These time delays are used to control the location that the listener(s) will perceive the phantom source to be located at (e.g., a distance from the video capture device that captured corresponding video, an angle with respect to the video capture device that captured the corresponding video, and/or the like). As η=[Γ]pᵣ, we have η=[Γ][R⁻¹]ξ, where [Γ] has been determined as part of the presentation data.

In various examples, phantom source delays are utilized to replicate the sound delays corresponding to a virtual or phantom source. For more “general” sources, or complex sources approximated to a lower order, one can match to a phantom multipole of order N. This expansion is unique to the source configuration and radiation pattern of the general and/or complex source, but once reduced to N poles, can be accounted for using the methods described herein.

At block 216, responsive to determining that a re-solve trigger has been identified during a presentation, updated listening space acoustic data may be determined and/or obtained and/or updated receiver data may be obtained. In various examples, a re-solve trigger is identified during a presentation in response to user input received via the user input interface 150 (e.g., changing a location of one or more sources on a video monitor and/or display within the listening space 105 indicating that a quantity/number of listeners or the locations of listeners have changed, and/or the like).

A re-solve trigger may also be identified in response to a determination made by the speaker control apparatus 110 based on sensor data captured by one or more sensors associated with the listening space 105, audio data captured by audio capture devices 140, and/or video data captured by video capture devices 130 that indicates a quantity/number of receivers within the listening space has changed more than a threshold amount (e.g., changed by at least a threshold percentage, changed by at least a threshold number, changed sufficiently to cause the particular presentation class of the presentation to change, and/or the like). In one example, a re-solve trigger is identified based on the speaker control apparatus 110 determining that one or more speakers 115 are not functioning properly (e.g., may be damaged or broken).

A re-solve trigger may further be identified in response to a determination made by the speaker control apparatus 110 based on sensor data captured by one or more sensors associated withing the listening space 105, audio data captured by audio capture devices 140, and/or video data captured by video capture devices 130 that indicates that locations of one or more listeners and/or receivers has changed by at least a threshold location change amount.

A re-solve trigger may be identified during a presentation in response to determining and/or identifying a change in at least one of receiver data, speaker arrangement data, listening space acoustic data, or source data that may affect the presentation data. For example, sensors within the listening space 105 (e.g., audio capture devices 140, video capture devices 130) may determine that the number of receivers 125, the location of the receivers 125, and/or the orientation of the receivers 125 have substantially changed at some point during the presentation. Such change may include, for example, listeners 120 within the listening space 105 migrating position to form discussion groups such that the locations of the receivers 125 change. In another example, an intermission may be taken during the presentation and not all of the listeners 120 may return after the intermission or new listeners 120 may enter the listening space 105 after the intermission or listeners may sit in different locations within the listening space 105 after the intermission.

In such scenarios, in response to determining that a re-solving trigger has been identified during the presentation (e.g., by the speaker control apparatus 110 or another computing entity), updated receiver data and/or updated listening space acoustic data is determined and/or obtained, updated presentation data is determined based at least in part on the updated receiver data (using the appropriate presentation solver instructions for the updated particular presentation class determined based at least in part on the updated receiver data), and the speakers 115 are controlled to provide the audio of another portion of the presentation within the listening space 105 in accordance with and/or based at least in part on the updated presentation data.

The updated presentation data may be determined multiple times during a presentation as necessary (e.g., based on data indicating changed receiver data as captured by the video capture devices 130, audio capture devices 140, and/or other sensors within the listening space and/or user input received via the user input interface 150). For example, if a phantom source location changed during the presentation (e.g., the locations of various speakers on a video monitor or the display position in the listening space 105 were rearranged), the presentation data may be determined based on the new phantom source locations.

Some example audio capture devices (or array of audio capture device elements) are provided based on similar concepts as those described above such that the audio capture devices (or array of audio capture device elements) are configured to isolate a source position. For example, an audio capture device system may be configured to isolate both source direction and source proximity. The determined position of the source within a presenting space may then be used when determining the acoustic pressure at the locations of receivers within a listening space where audio generated by the source is provided as from a remote, virtual source. In another example, audio data captured by audio capture devices may be used to determine the quantity and/or number, location, and/or orientation of receivers within the listening space.

### Example Technical Advantages

Various examples described herein provide for the operation of speakers within a listening space so as to replicate the spatial distribution of acoustic pressure of one or more virtual or phantom sources. Various examples enable listening space systems to determine and isolate the position of a phantom source when determining the spatial distribution of acoustic pressure within a listening space. Notably, in many examples, listening space systems are configured to shape such spatial distributions not only on such phantom source position but also using aspects (including physical aspects) of the listening space including listening space acoustic data, the quantity, location, and/or orientation of receivers in the listening space, and speaker arrangement data.

### Example Speaker Control Apparatus

In various examples, a speaker control apparatus 110 is a computing entity such as a server, desktop computer, laptop, tablet, or cloud-based computing resource. As shown in FIG. 2, in various examples, the speaker control apparatus 110 comprises various elements including processing element(s) 305, memory 310, speaker controller elements 315, a communication interface 320, and/or the like. In various examples, the speaker control apparatus 110 is configured to obtain speaker arrangement data for a listening space, obtain listening space acoustic data, determine data regarding receivers within the listening space, determine a presentation class, determine presentation data based on the presentation class, and control speakers within the listening space to provide audio of a presentation in accordance with the presentation data. In various examples, the speaker control apparatus 110 may contain additional and/or alternative elements configured to perform various functions of the speaker control apparatus 110 described herein and/or to perform additional functions of the speaker control apparatus 110.

In various examples, the processing element(s) 305 comprise processing devices such as programmable logic devices (CPLDs), processors, multi-core processors, microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing elements and/or circuitry, and/or the like. The term circuitry may refer to an entirely hardware embodiment or a combination of hardware and computer program products.

In various examples, the memory 310 comprises non-transitory memory such as volatile and/or non-volatile memory storage such as one or more of hard disks, ROM, PROM, EPROM, EEPROM, flash memory, MMCs, SD memory cards, memory sticks, CBRAM, PRAM, FcRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various examples, the memory 310 may store computer program code and/or one or more sets of executable instructions, and/or the like that, when executed by one or more of the processing elements 305, causes the speaker control apparatus 110 to perform various functions described herein and/or additional functions of the speaker control apparatus 110. For example, the memory 310 may store presentation solver instructions corresponding to one or more presentation classes, speaker arrangement data for a listening space, space acoustic data for a listening space, and/or the like.

In various examples, the speaker controller elements 315 include one or more speaker drivers and/or controller elements configured to control operation of one or more speaker drivers that are each configured to control one or more speakers 115. For example, the speaker controller elements 315 may be configured to cause one or more corresponding speaker drivers to operate respective speakers 115 to provide audio in accordance with the presentation data.

In various examples, the speaker control apparatus 110 may comprise a communication interface 320 for interfacing and/or communicating with, for example, one or more computing entities, the user input interface 150, and/or the like. For example, the speaker control apparatus 110 may comprise a communication interface 320 for receiving presentations from one or more computing entities, receiving indications of user input received via the user input interface 150, and providing output to one or more video monitors or displays within a listening space, and/or the like. In various examples, the speaker control apparatus 110 is configured to communicate (via the communication interface 320) via a direct wired and/or wireless connection and/or via one or more wired and/or wireless networks.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising one or more processors and at least one memory, the memory storing computer-executable instructions, the computer-executable instructions configured to, when executed by the one or more processors, cause the apparatus to: receive speaker arrangement data indicating a speaker arrangement associated with a listening space; determine receiver data for one or more receivers located within the listening space at a time corresponding to a presentation being provided within the listening space; determine, based at least in part on the speaker arrangement data and the receiver data, presentation data corresponding to the presentation being provided within the listening space; and adjust one or more parameters of the one or more speakers within the listening space based on the presentation data to enable provision of audio associated with the presentation within the listening space.

Clause 2. The apparatus of clause 1, wherein the computer-executable instructions are further configured to, when executed by the one or more processors, cause the apparatus to determine a particular presentation class for the presentation based at least in part on the speaker arrangement data and the receiver data, the presentation data is determined at least in part based on the particular presentation class, the particular presentation class is one of a plurality of presentation classes, and each of the plurality of presentation classes corresponds to a respective range of a ratio of quantity of receivers within the listening space, as indicated by the receiver data, to a quantity of speakers of the one or more speakers within the listening space.

Clause 3. The apparatus of clause 2, wherein the plurality of presentation classes comprises (a) a receiver heavy class corresponding to scenarios where the quantity of receivers within the listening space is greater than the quantity of speakers, (b) a balanced class corresponding to scenarios where the quantity of receivers within the listening space is equal to the quantity of speakers, and (c) a speaker heavy class corresponding to scenarios where the quantity of receivers within the listening space is less than the quantity of speakers.

Clause 4. The apparatus of clause 2 or 3, wherein at least a portion of the presentation data is determined by presentation solver instructions corresponding to the particular presentation class, and respective computer executable presentation solver instructions corresponding to each presentation class of the plurality of presentation classes are stored in a memory accessible to the one or more processors.

Clause 5. The apparatus of clause 4, wherein the respective presentation solver instructions differ from one another in at least one of an algorithm performed by execution of the respective computer-executable instructions.

Clause 6. The apparatus of any of clauses 1-5, wherein the receiver data indicates a quantity of receivers within the listening space, respective locations of the receivers within the listening space, and respective orientations of the receivers within the listening space.

Clause 7. The apparatus of any of clauses 1-6, wherein a receiver data application is configured to determine the receiver data based at least in part on at least one of processing audio data captured by one or more audio capture devices within the listening space or image data captured by one or more video capture devices within the listening space to identify at least one of respective locations or respective orientations of receivers within the listening space.

Clause 8. The apparatus of any of clauses 1-7, wherein a receiver data application is configured to determine the receiver data based at least in part on processing sensor data captured by one or more sensors within the listening space to identify at least respective locations of receivers within the listening space.

Clause 9. The apparatus of any of clauses 1-8, wherein the speaker arrangement data indicates a quantity of speakers within the listening space and respective locations of the speakers within the listening space.

Clause 10. The apparatus of any of clauses 1-9, wherein the computer-executable instructions are further configured to, when executed by the one or more processors, cause the apparatus to receive or determine acoustic data for the listening space and using the acoustic data in determining the presentation data.

Clause 11. The apparatus of clause 10, wherein the acoustic data indicates at least one of a location or a characterization of at least one scatterer within the listening space.

Clause 12. The apparatus of any of clauses 1-11, wherein the computer-executable instructions are further configured to, when executed by the one or more processors, cause the apparatus to: determine that a re-solve trigger has been identified during the presentation; determine updated receiver data for the listening space; determine updated presentation data based at least in part on the updated receiver data; and adjust one or more parameters of the one or more speakers within the listening space in accordance with the updated presentation data to enable provision of audio associated with the presentation within the listening space.

Clause 13. The apparatus of any of clauses 1-12, wherein the apparatus is a speaker driver configured to drive the at least one of the one or more speakers or a computing entity in communication with a speaker driver of the at least one of the one or more speakers.

Clause 14. An apparatus comprising one or more processors and at least one memory, the memory storing computer-executable instructions, the computer-executable instructions configured to, when executed by the one or more processors, cause the apparatus to: adjust one or more parameters of one or more speakers within a listening space based at least in part on presentation data corresponding to the listening space to enable provision of audio of at least a portion of a presentation within the listening space, wherein the presentation data is determined based at least in part on respective locations of the one or more speakers, respective locations of one or more receivers within the listening space, and a comparison of a quantity of the one or more speakers and a quantity of the one or more receivers.

Clause 15. A method performed by a speaker control apparatus, the method comprising: receiving, by the speaker control apparatus, speaker arrangement data indicating a speaker arrangement associated with a listening space; determining, by the speaker control apparatus, receiver data for one or more receivers located within the listening space at a time corresponding to a presentation being provided within the listening space; determining, by the speaker control apparatus and based at least in part on the speaker arrangement data and the receiver data, presentation data corresponding to the presentation being provided within the listening space; and adjusting, by the speaker control apparatus, one or more parameters of the one or more speakers within the listening space based on the presentation data to enable provision of audio associated with the presentation within the listening space.

Clause 16. The method of clause 15, further comprising determining a particular presentation class for the presentation based at least in part on the speaker arrangement data and the receiver data, wherein the presentation data is determined at least in part based on the particular presentation class, the particular presentation class is one of a plurality of presentation classes, and each of the plurality of presentation classes corresponds to a respective range of a ratio of quantity of receivers within the listening space, as indicated by the receiver data, to a quantity of speakers of the one or more speakers within the listening space.

Clause 17. The method of clause 16, wherein the plurality of presentation classes comprises (a) a receiver heavy class corresponding to scenarios where the quantity of receivers within the listening space is greater than the quantity of speakers, (b) a balanced class corresponding to scenarios where the quantity of receivers within the listening space is equal to the quantity of speakers, and (c) a speaker heavy class corresponding to scenarios where the quantity of receivers within the listening space is less than the quantity of speakers.

Clause 18. The method of clause 16 or 17, wherein at least a portion of the presentation data is determined by presentation solver instructions corresponding to the particular presentation class, and respective computer executable presentation solver instructions corresponding to each presentation class of the plurality of presentation classes are stored in a memory accessible to the one or more processors.

Clause 19. The method of clause 18, wherein the respective presentation solver instructions differ from one another in at least one of an algorithm performed by execution of the respective presentation solver instructions.

Clause 20. The method of any of clauses 15-19, wherein the method further comprises: determining that a re-solving trigger has been identified during the presentation; determining updated receiver data for the listening space; determining updated presentation data based at least in part on the updated receiver data; and adjusting one or more parameters of the one or more speakers within the listening space in accordance with the updated presentation data to enable provision of audio associated with the presentation within the listening space.

### CONCLUSION

Many modifications and other embodiments of the disclosure set forth herein will come to mind to one skilled in the art to which this disclosure pertains having the benefit of the teachings presented in the foregoing descriptions and the associated drawings. Therefore, it is to be understood that the claims are not to be limited to the specific examples disclosed and that modifications and other embodiments are intended to be included within the scope of the appended claims. Although specific terms are employed herein, they are used in a generic and descriptive sense only and not for purposes of limitation.

That which is claimed:

1. An apparatus comprising one or more processors and at least one memory, the memory storing computer-executable instructions, the computer-executable instructions configured to, when executed by the one or more processors, cause the apparatus to:
receive speaker arrangement data indicating a speaker arrangement associated with a listening space;
determine receiver data for one or more receivers located within the listening space at a time corresponding to a presentation being provided within the listening space;
determine, based at least in part on the speaker arrangement data and the receiver data, presentation data corresponding to the presentation being provided within the listening space; and
adjust one or more parameters of one or more speakers within the listening space based on the presentation data to enable provision of audio associated with the presentation within the listening space.

2. The apparatus of claim 1, wherein the computer-executable instructions are further configured to, when executed by the one or more processors, cause the apparatus to determine a particular presentation class for the presentation based at least in part on the speaker arrangement data and the receiver data, the presentation data is determined at least in part based on the particular presentation class, the particular presentation class is one of a plurality of presentation classes, and each of the plurality of presentation classes corresponds to a respective range of a ratio of quantity of receivers within the listening space, as indicated by the receiver data, to a quantity of speakers of the one or more speakers within the listening space.

3. The apparatus of claim 2, wherein the plurality of presentation classes comprises (a) a receiver heavy class corresponding to scenarios where the quantity of receivers within the listening space is greater than the quantity of speakers, (b) a balanced class corresponding to scenarios where the quantity of receivers within the listening space is equal to the quantity of speakers, and (c) a speaker heavy class corresponding to scenarios where the quantity of receivers within the listening space is less than the quantity of speakers.

4. The apparatus of claim 2, wherein at least a portion of the presentation data is determined by presentation solver instructions corresponding to the particular presentation class, and respective computer executable presentation solver instructions corresponding to each presentation class of the plurality of presentation classes are stored in a memory accessible to the one or more processors.

5. The apparatus of claim 4, wherein the respective presentation solver instructions differ from one another in at least one of an algorithm performed by execution of the respective computer-executable instructions.

6. The apparatus of claim 1, wherein the receiver data indicates a quantity of receivers within the listening space, respective locations of the one or more receivers within the listening space, and respective orientations of the one or more receivers within the listening space.

7. The apparatus of claim 1, wherein a receiver data application is configured to determine the receiver data based at least in part on at least one of processing audio data captured by one or more audio capture devices within the listening space or image data captured by one or more video capture devices within the listening space to identify at least one of respective locations or respective orientations of receivers within the listening space.

8. The apparatus of claim 1, wherein a receiver data application is configured to determine the receiver data based at least in part on processing sensor data captured by one or more sensors within the listening space to identify at least respective locations of receivers within the listening space.

9. The apparatus of claim 1, wherein the speaker arrangement data indicates a quantity of speakers within the listening space and respective locations of the one or more speakers within the listening space.

10. The apparatus of claim 1, wherein the computer-executable instructions are further configured to, when executed by the one or more processors, cause the apparatus to receive or determine acoustic data for the listening space and using the acoustic data in determining the presentation data.

11. The apparatus of claim 10, wherein the acoustic data indicates at least one of a location or a characterization of at least one scatterer within the listening space.

12. The apparatus of claim 1, wherein the computer-executable instructions are further configured to, when executed by the one or more processors, cause the apparatus to:
determine that a re-solve trigger has been identified during the presentation;
determine updated receiver data for the listening space;
determine updated presentation data based at least in part on the updated receiver data; and
adjust at least one of the one or more parameters of the one or more speakers within the listening space in accordance with the updated presentation data to enable provision of audio associated with the presentation within the listening space.

13. The apparatus of claim 1, wherein the apparatus is a speaker driver configured to drive the at least one of the one or more speakers or a computing entity in communication with the speaker driver of the at least one of the one or more speakers.

14. An apparatus comprising one or more processors and at least one memory, the memory storing computer-executable instructions, the computer-executable instructions configured to, when executed by the one or more processors, cause the apparatus to:
adjust one or more parameters of one or more speakers within a listening space based at least in part on presentation data corresponding to the listening space to enable provision of audio of at least a portion of a presentation within the listening space, wherein the presentation data is determined based at least in part on respective locations of the one or more speakers, respective locations of one or more receivers within the listening space, and a comparison of a quantity of the one or more speakers and a quantity of the one or more receivers.

15. A method performed by a speaker control apparatus, the method comprising:
receiving, by the speaker control apparatus, speaker arrangement data indicating a speaker arrangement associated with a listening space;
determining, by the speaker control apparatus, receiver data for one or more receivers located within the listening space at a time corresponding to a presentation being provided within the listening space;
determining, by the speaker control apparatus and based at least in part on the speaker arrangement data and the receiver data, presentation data corresponding to the presentation being provided within the listening space; and
adjusting, by the speaker control apparatus, one or more parameters of one or more speakers within the listening space based on the presentation data to enable provision of audio associated with the presentation within the listening space.

16. The method of claim 15, further comprising determining a particular presentation class for the presentation based at least in part on the speaker arrangement data and the receiver data, wherein the presentation data is determined at least in part based on the particular presentation class, the particular presentation class is one of a plurality of presentation classes, and each of the plurality of presentation classes corresponds to a respective range of a ratio of quantity of receivers within the listening space, as indicated by the receiver data, to a quantity of speakers of the one or more speakers within the listening space.

17. The method of claim 16, wherein the plurality of presentation classes comprises (a) a receiver heavy class corresponding to scenarios where the quantity of receivers within the listening space is greater than the quantity of speakers, (b) a balanced class corresponding to scenarios where the quantity of receivers within the listening space is equal to the quantity of speakers, and (c) a speaker heavy class corresponding to scenarios where the quantity of receivers within the listening space is less than the quantity of speakers.

18. The method of claim 16, wherein at least a portion of the presentation data is determined by presentation solver instructions corresponding to the particular presentation class, and respective computer executable presentation solver instructions corresponding to each presentation class of the plurality of presentation classes are stored in a memory accessible to the speaker control apparatus.

19. The method of claim 18, wherein the respective presentation solver instructions differ from one another in at least one of an algorithm performed by execution of the respective presentation solver instructions.

20. The method of claim 15, wherein the method further comprises:
determining that a re-solving trigger has been identified during the presentation;
determining updated receiver data for the listening space;
determining updated presentation data based at least in part on the updated receiver data; and
adjusting at least one of the one or more parameters of the one or more speakers within the listening space in accordance with the updated presentation data to enable provision of audio associated with the presentation within the listening space.
